(19) United States
(12) Patent Application Publication
(10) Pub. No.: US 2026/0042904 A1
(43) Pub. Date: Feb. 12, 2026

(54) LASER-WELDABLE POLYESTER COMPOSITION, PREPARATION AND PROCESSING THEREOF AND APPLICATIONS THEREOF

(71) Applicant: ENVALIOR B.V., GELEEN (NL)

(72) Inventors: Xinchao GUAN, GELEEN (NL); Zhihao CAI, GELEEN (NL); Frank Peter Theodorus Johannes VAN DER BURGT, GELEEN (NL); Luigi BALZANO, GELEEN (NL)

(21) Appl. No.: 19/101,368

(22) PCT Filed: Aug. 1, 2023
(86) PCT No.: PCT/EP2023/071223

§ 371 Date: Feb. 5, 2025

(30) Foreign Application Priority Data
Aug. 12, 2022 (WO) PCT/CN2022/112230
Sep. 12, 2022 (EP) 22195024.9

(51) Int. Cl. C08K 7/14; B29C 65/00; B29C 65/16; B29K 67/00; B29K 309/08; C08J 3/20; C08K 5/09

(52) U.S. Cl. CPC C08K 7/14; B29C 65/1635; B29C 66/72326; C08J 3/203; C08K 5/09; B29K 2067/006; B29K 2309/08; B29K 2995/0027; B29K 2995/0077; B29K 2995/0089; C08J 2367/06

(57) ABSTRACT

The present invention relates to a laser-weldable polyester composition, more particular to a laser-weldable fibre-rein-forced polybutylene terephthalate composition comprising: (A) a poly butylene terephthalate resin (PBT); (B) glass fibres; and (C) an alkali metal salt of a fatty acid with 24-40 carbon atoms; wherein component (B) is present in an amount in a range of 15-100 parts by weight, relative to 100 parts by weight of component (A) and component (C) is present in an amount in a range of 1.75-4.5 parts by weight, relative to 100 parts by weight of component (A). The invention also relates to —a process for preparing the laser-weldable fibre-reinforced polyester composition, —a process for making a moulded part from the laser-weldable fibre-reinforced polyester composition, —a laser transparent moulded part made of the laser-weldable fibre-reinforced polyester composition, to —a process for laser welding the laser transparent moulded part made of the laser-weldable fibre-reinforced polyester composition on laser-light-absorbent polymeric substrate, and —a composite article comprising the moulded article made of the laser-weldable fibre-reinforced polyester composition bonded by laser welding on a laser-light-absorbent polymeric substrate.

The present invention relates to a laser-weldable polyester composition, more particular to a laser-weldable fibre-reinforced polyester composition comprising a polybutylene terephthalate resin and glass fibres. The invention also relates to
a process for preparing a laser-weldable fibre-reinforced polyester composition;
a process for making a moulded part from a laser-weldable fibre-reinforced polyester composition;
a laser transparent moulded part made of a laser-weldable fibre-reinforced polyester composition;
a process for laser welding a laser transparent moulded part made of a laser-weldable fibre-reinforced polyester composition on laser-light-absorbent polymeric substrate; and
a composite article comprising a moulded article made of a laser-weldable fibre-reinforced polyester composition bonded by laser welding on a laser-light-absorbent polymeric substrate.

There are various processes for welding plastics mouldings, such as heated-tool welding, vibration welding and laser welding. Laser transmission welding is a method providing an alternative to vibration welding and heated-tool welding and has seen a constant increase in its use in recent times, in particular with use of diode lasers. Laser-weldable polyester compositions are known from the prior art and are described in various patents or patent applications.

US2008153957 describes a laser-weldable polyester composition. The composition of US2008153957 comprises (A) a polybutylene terephthalate (PBT) resin and (B) a fatty acid compound in an amount in the range of 0.01 to 1.0 part by weight (pbw), preferably about 0.03 to 0.5 pbw, relative to 100 pbw of PBT resin. The fatty acid compound suitably is a fatty acid ester, a fatty acid amide or a metal salt of C12-36 fatty acid. The metal salt of the C12-36 fatty acid may include, for example, singly or in combination, an alkali metal salt (e.g., a sodium salt and a potassium salt), an alkaline earth metal salt (e.g., a magnesium salt and a calcium salt), a salt of a metal of the group 2B of the Periodic Table of Elements (e.g., a zinc salt), and a salt of a metal of the group 3B of the Periodic Table of Elements (e.g., an aluminium salt). According to US2008153957, the addition of the fatty acid-series compound to the resin composition in a specific low proportion as described above efficiently ensures improvement of the laser transmissivity, while with a lower proportion of the fatty acid-series compound, improvement of the laser transmissivity is not enough, while, on the other hand, with a higher proportion of the fatty acid-series compound, there is a possibility that the laser transmissivity is deteriorated. The composition of US2008153957 may comprise further components, such as fibres and filler and other auxiliary additives for PBT-based polyester compositions. A further component in the composition of US2008153957, mentioned as an optional component (C), was a cyclic polyester oligomer. However, in the examples in US2008153957 component (B) showed a moderate effect on the transparency as well as on the welding strength, while component (C) showed a small additional effect on the transparency, but a much more pronounced effect on the welding strength.

US2011288220 describes a composition for laser transparent mouldings, the composition comprising (A) a polyester and (B) sodium or potassium carbonate or sodium or potassium bicarbonate. The composition may comprise (C) further additives. Component (B) is present in an amount in the range of 0.05 to 2.0 wt. % relative to the total weight of the composition and is added to enhance the laser light transparency. Among the further additives are reinforcing fibres, lubricants, and mould release agents. As possible lubricants and mould release agents, long chain fatty acids and salts thereof are mentioned. As mentioned in US2011288220 these are used in an amount up to 1 wt. %. In US2011288220 a series of examples of compositions comprising PBT and a variable amount of a component (B) additive without glass fibres and a series of examples of compositions comprising PBT, a variable amount of a component (B) additive and 30 wt. % glass fibres. Both series showed an optimum in laser light transmittance in respect of the amount of component (B). The first series showed the highest laser light transmittance at an amount in the range of 0.4-0.5 wt. % of component (B), the second series at an amount in the range of 0.3-0.4 wt. % of component (B). These weight percentages correspond with 0.40-0.50 pbw of component (B), relative to 100 pbw of PBT resin, for the first series; and 0.42-0.57 pbw of component (B), relative to 100 pbw of PBT resin, for the second series. Furthermore, for all corresponding compositions with the same amount of component (B), the laser light transmittance of the glass-fibre-reinforced compositions was lower than for the non-reinforced compositions.

Patent application US2012231285 describes the use of thermoplastic moulding compositions for producing laser-transparent mouldings, the compositions comprising (A) a polyester, (B) an alkali metal salt of aliphatic carboxylic acid, and optionally (C) further additives. The amount of the said alkali metal salt (B) is from 0.2 to 2% by weight, based on 100% by weight of (A) and (B). The composition may comprise further additives, up to 70 wt. % of the composition. Preferred alkali metals in the alkali metal salt of component (B) are potassium and/or sodium. Furthermore, preference is given to saturated or unsaturated carboxylic acids having from 1 to 40, more preferably from 1 to 22, carbon atoms. Several examples of compositions based on PBT as component (A), and variable amounts of either sodium acetate or sodium stearate as component (B) are given. With increasing the amount of the alkali metal salt of aliphatic carboxylic acid (B) up to a level of about 0.8-1.0 wt. % for both sodium acetate or sodium stearate, the laser light transparency increases significantly, while beyond this amount the increase in laser light transparency levels of, or the laser light transparency even goes down. Meanwhile, up to a level of about 0.8-1.0 wt. % the tensile strength remains about constant, but beyond that amount the tensile strength goes down. Furthermore, already with the addition of a small amount of either sodium acetate or sodium stearate, the tensile strain at break goes down drastically and further degrades systematically with the increase in amount for both sodium acetate and sodium stearate.

Overall, there is a need for laser-weldable compositions, in particular laser-weldable polyester compositions, which have high laser light transparency and good weldability as well as good mechanical properties, especially tensile strength, elongation at break and impact strength. And although mechanical properties may be enhanced by adding reinforcing agents, such components reduce the laser light transparency. On the other hand, addition of laser light transparency enhancing additives not only has its own limits in the effect on the laser light transparency, but also have, as shown above, an unwanted negative effect on the mechanical properties of PBT-based polyester compositions.

Therefore, the aim of the present invention is to provide a laser-weldable polyester composition, more particular a laser-weldable fibre-reinforced polyester composition, that has an improved balance in laser light transparency and mechanical properties, and preferably has both good laser light transparency and good mechanical properties.

This aim has been achieved with the fibre-reinforced polyester composition according to the present invention, comprising (A) a polybutylene terephthalate resin (PBT); (B) glass fibres; and (C) an alkali metal salt of a fatty acid with 24-40 carbon atoms. The glass fibres (component (B)) are herein present in an amount in the range of 15-100 parts by weight, relative to 100 parts by weight of the PBT (component (A)). The alkali metal salt of the fatty acid with 24-40 carbon atoms (component (C)) is herein present in an amount in the range of 1.75-4.50 parts by weight, relative to 100 parts by weight of component (A).

The effect of the composition according to the present invention, comprising component (C) in the said amount, is that the laser light transparency is significantly increased, allowing laser welding cycle times significantly be shortened, while the mechanical properties remain at a prominent level. More particularly, the laser light transparency is increased more than could be expected on the basis of the increase at 1 pbw of component (C), whereas regarding the mechanical properties, more particular the tensile strength, elongation at break and/or unnotched impact properties, although lower than those of the corresponding composition without component (C), the reduction thereof is much less than for corresponding compositions comprising, for example, sodium stearate or sodium myristate instead of component (C) in the same amount. Furthermore, the laser light transparency is increased much more than with corresponding metal salts of C24-C40 fatty acids based on other metals, such as magnesium (a metal from the group of alkaline earth metals) and aluminium (a metal of the group 3B of the Periodic Table of Elements).

It is noted that in expressions wherein a range with an upper limit and/or a lower limit is mentioned, the range explicitly includes any value within the range as well as the mentioned upper limit and the mentioned lower limit. For example, in ‘an amount in the range of 1.75-4.50 parts by weight’, the range explicitly includes 1.75 and 4.50 and any value between 1.75 and 4.50.

It is noted that during the preparation of the inventive composition, wherein the components (A), (B) and (C) are mixed, for example by melt-mixing, some reactions between the polybutylene terephthalate resin (PBT; component (A)) and the alkali metal salt of a fatty acid (component (C)) may have taken place. Thus, in the composition according to the invention component (A) and component (C) may be present as reaction products resulting from reactions between component (A) and component (C). Reactions that might have taken place are, for example, trans-esterification and salt-exchange.

In the trans-esterification, a terephthalate carboxyl group and a fatty acid carboxyl group may have been exchanged, resulting in a fatty acid carboxyl group incorporated as an end-group in a polyester chain and a polyester chain with an alkali metal salt of a carboxylic acid end group, as is represented in reaction (I):

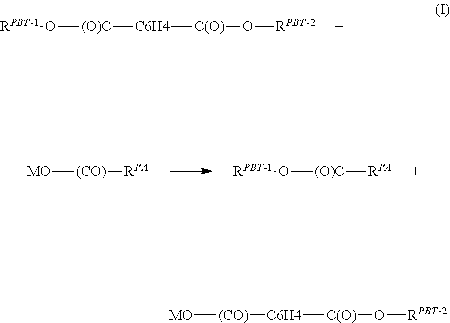

In the salt-exchange reaction, also referred to as ion-exchange reaction, a reaction between a protonated carboxylic acid end-group in a polyester chain, comprising a proton (H) and a carboxylic acid group (R^{PBT}—C(O)—O), and the alkali metal salt of the fatty acid, comprising an alkali metal ion (M) and a carboxylic group (O—C(O)—R^{FA}), may have taken place wherein the proton and the alkali metal ion have been exchanged, resulting in a protonated in fatty acid HO—(CO)—R^{FA} and a polyester chain with an alkali metal salt of a carboxylic acid end group, as is represented in reaction (II):

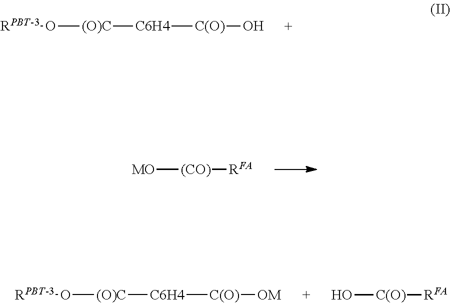

Herein R^{PBT-1}, R^{PBT-2} and R^{PBT-3} represent a polyester chain with repeating units derived from, or primarily from diacids and diols, more particularly predominantly from terephthalic acid and butane diol. R^{FA} represents the aliphatic chain of the fatty acid. The aliphatic chain R^{FA} comprises 23-39 carbon atoms, whereas the corresponding carboxylic functional fatty acid group O—(CO)—R^{FA} comprises 24-40 carbon atoms. MO—(CO)—represents the alkali salt of a carboxylic acid group. —C(O)—OH represents a protonated carboxylic acid group. —C6H4- represents an aromatic ring of a terephthalic acid group.

Thus, in the composition according to the invention, component (A) and component (C) may be present as such, or as a reaction product thereof, or in a combination thereof, i.e. partly as such, and partly form of a reaction product thereof. Where in the invention described herein, the amounts of component (A) and component (C) are expressed, either in wt. %, or in parts by weight, the amount of component (C) refers to the combined weight amount of alkali metal ion (M; added by addition of the component MO—(CO)—R^{FA} in the recipe), and C24-C40 carboxylic functional fatty acid group O—(CO)—R^{FA}, with its weight taken excluding any protonated and/or esterified group attached thereto; and the amount of component (A) refers to the combined amount of components in the polyester chain, excluding any alkali metal ion or carboxylic functional C24-C40 fatty acid group therein. In other words, for clarification: the bold parts in the following structures are included in the amount of component (A), whereas the underlined parts are included in the amount of component (C):
—R^{PBT-a}—C(O)—O—R^{PBT-b} (polyester chain),
R^{PBT-a}—C(O)—O—H (polyester chain with protonated carboxylic acid group)
R^{PBT-c}—C(O)—O-M (polyester chain with pending alkalimetal ion),
R^{FA}—C(O)—O—R^{PBT-d}, (polyester chain with pending carboxylic functional C24-C40 fatty acid group),
R^{FA}—C(O)—O-M (alkalimetal salt of C24-C40 fatty acid); and
R^{FA}—C(O)—O—H (protonated C24-C40 carboxylic functional fatty acid group).
   The amounts are determined by the quantities of components used in the preparation of the compositions and can be quantified in a composition or injection moulded part by techniques known by a person skilled in the art, using hydrolysis, acidification, 1H-NMR solution spectroscopy and HPLC or GC for the soluble components.

An example of an alkali metal salt of a fatty acid with 24-40 carbon atoms is sodium montanate: MO—(CO)—C27H55 with M is sodium (Na; molar mass=22.99) and carboxylic acid function is C28H2502 (molar mass=423.75 g/mol).

Polymer compositions comprising PBT and sodium montanate are known, for example, from US 2010/0227182. This patent application describes a polyester composition comprising PBT, or other thermoplastic polyesters, and sodium montanate, and are typically non-reinforced. The polyester composition is used for application in bezels. The sodium montanate herein is used as a lubricant, and the amount thereof is 0.01 to 0.5 wt. % based on the total weight of the composition. US 2010/0227182 focuses on low-outgassing of the bezels, and is silent about any polymer welding behaviour, laser light transparency or the effect of sodium montanate on the mechanical properties of moulded parts made of fibre-reinforced compositions.

Component (A) in the composition according to the invention is a polybutylene terephthalate (PBT) resin. The PBT resin can be any thermoplastic polybutylene terephthalate resin suitable for being used in fibre-reinforced polymer compositions suitable for making fibre-reinforced moulded parts in a moulding process, and are known in the art.

The polybutylene terephthalate resin suitably is a PBT homopolymer or a PBT copolymer. The PBT homopolymer consists mainly of copolymerized units of butylene and terephthalate. Such a homopolymer can suitably be prepared by copolymerization of butane diol and terephthalic acid, wherein these monomers are used as the only monomers. The PBT homopolymer may contain other copolymerized units resulting from traces of other components; for example, trace impurities in the butane diol and/or terephthalic acid, or trace impurities formed during the polycondensation of butane diol and terephthalic acid. Suitably the PBT homopolymer consists of at least 99 mole % of butylene units and terephthalate units, and at most 1 mole % of other copolymerized units, relative to the total molar amount of butylene units, terephthalate units and other copolymerized units.

The PBT copolymer may comprise other comonomers and such comonomers may be copolymerized into the copolymer chain in minor amounts. Examples of such other comonomers include difunctional monomers, i.e., monomers with two reactive sites, such as other diacids, for example isophthalic acid, other diols, such as ethylene glycol, and functional comonomers, for example 5-sodium sulphoisophthalate. Difunctional comonomers are suitably present, if at all, in an amount of up to about 10 mol or up to about 5 mol %. Comonomers that have more than two reactive sites, for example trimellitic anhydride, trimellitic acid, pyromellitic dianhydride (pmda), and pentaerythritol, may suitably be incorporated as branching agents to increase the melt viscosity. Such comonomers having more than two reactive sites are suitably present, if at all, in an amount of up to about 5 mol %, or even better up to about 2.0 mol %. Suitably, the PBT copolymer contains at least about 85 mol % of copolymerized units of butylene (butylene units) and terephthalate (terephthalate units) and at most about 15 mol % of copolymerized units of further comonomers (comonomer units). Examples of further comonomers that may be copolymerized into the PBT copolymer are, for example, isophthalic acid, propylene glycol and butylene glycol. Preferably, the PBT copolymer contains at least about 90 mol %, more preferably at least about 95 mol %, or even more preferably at least about 98 mol %, of butylene units and terephthalate units; and correspondingly preferably at most about 10 mol %, more preferably at most about 5 mol %, or even more preferably at most about 2.0 mol %, of comonomer units. Herein the mol percentages (mol %) of butylene units, terephthalate units and comonomer units are all relative to the total molar amount of moles of butylene units, moles of terephthalate units and moles of comonomers units in the copolymer.

In a preferred embodiment of the composition of the invention, the PBT resin is a PBT homopolymer, or a PBT copolymer containing at least 98 mol % of copolymerized units of butylene and terephthalate, and at most about 2.0 mol % of copolymerized units of comonomers, relative to the total molar amount of moles of butylene units, moles of terephthalate units and moles of comonomers units in the copolymer.

The polybutylene terephthalate resin (A) used for the preparation of the composition according to the invention may be any polybutylene terephthalate resin commonly used for preparation of thermoplastic polyester moulding compositions. The resin may have properties, such as viscosity and melt flow ratio, varying accordingly. Suitably, the polybutylene terephthalate resin has a relative solution viscosity as high as about 2.8, or even higher than 2.8, or as low as about 1.5, or even lower than 1.5. Preferably, the PBT resin has a RSV in the range of 1.8-2.6, more preferably in the range of 2.0-2.5. Herein, the relative solution viscosity (RSV) is measured in m-cresol at a concentration of 1 g in 100 g m-cresol at a temperature of 25° C. by the method according to ISO 307.

The advantage of the PBT resin having a lower viscosity is that the laser-weldable fibre-reinforced polyester composition has improved processing behaviour, while the advantage for a higher viscosity is that moulded parts made of the composition has better mechanical properties. The advantage of the PBT resin having a viscosity in the preferred range is that the composition combines good processing behaviour and good mechanical properties. The advantage of the PBT resin having a viscosity in the more preferred range is that the composition has an even better balance in processing behaviour and mechanical properties.

In a preferred embodiment, the PBT resin in the laser-weldable fibre-reinforced polyester composition has a relative solution viscosity (RSV) of 2.4 or less. Based on the value in experiments. The advantage thereof is that the welding process is improved, i.e., either a shorter cycle time is required for a certain bonding strength, or a higher bonding strength is attained with the same cycle time, compared with compositions comprising a corresponding PBT resin with a higher viscosity.

Suitably, the laser-weldable fibre-reinforced polyester composition comprises component (A) in an amount in the range of 40-85 wt. %, relative to the total weight of the composition. The amount can be for example, as low as, or about, 45 wt. %, 50 wt. %, 55 wt. %, or 58, or as high as, or about, 80 wt. %, 75 wt. %, or 70 wt. %, relative to the total weight of the composition.

For the glass fibres of component (B), any glass fibres suitable for use in fibre-reinforced polyester compositions and in moulding processes for making fibre-reinforced moulded parts from such compositions, can be used. Suitable glass fibres are known in the art. The glass fibres for making the laser-weldable fibre-reinforced polyester composition according to the present invention may have a length varying over a wide range. These can be used in the form of rovings or of chopped glass in the forms commercially obtainable. The glass fibres can be added as continuous fibres or as cut or ground glass fibres, it being possible for the fibres to be equipped with a suitable sizing system and an adhesion promoter or adhesion promoter system, for example based on silane. Particular preference is given here to glass fibres in the form of E-glass (alumino-borosilicate glass with less than 1 wt. % alkali oxides mainly used for glass-reinforced plastics), but also other types of glass fibres may be used, such as A-glass (alkali-lime glass with little or no boron oxide), E-CR-glass (alumino-lime silicate with less than 1 wt. % alkali oxides, has high acid resistance), C-glass (alkali-lime glass with high boron oxide content used, for example for glass staple fibres), D-glass (borosilicate glass with high dielectric constant), R-glass (alumino silicate glass without MgO and CaO, with high mechanical requirements), and S-glass (alumino silicate glass without CaO but with high MgO content with high tensile strength). The glass fibres suitably have a fibre diameter between 3 and 20 μm (micrometre). The glass fibres may have cross sections with different shapes. The glass fibres suitably have a circular cross section. These glass fibres may have a number average diameter of, for example, about 7 μm, about 8 μm, or about 9 μm, or about 10 μm, or about 12 μm, or about 15 μm. Preferably, the number average diameter is in the range of 8-15 μm, more preferably in the range of 9-12 μm. The glass fibres may also have a non-circular cross section, for example an oblong cross section or an ellipsoid oblong cross section. A non-circular cross section is herein characterized by a cross-section with different diameters in different directions. Suitably, the glass fibres having a non-circular cross section have a cross section with a largest diameter of for example, about 5 μm, or about 8 μm, or about 9 μm, or about 10 μm, or about 12 μm, or about 15 μm, or about 18 μm. Preferably, the number average value of the largest diameter is in the range of 9-18 μm, more preferably in the range of 10-15 μm.

Component (B), i.e., the glass fibres, is present in an amount in the range of 15-100 pbw, relative to 100 pbw of component (A). Preferably the amount of component (B) is in the range of 25-80 pbw, more preferably 30-70 pbw, even more preferably 35-60 pbw, relative to 100 pbw of component (A). A higher minimum amount of component (B) has the advantage that the mechanical properties of the composition are better, more particularly that the tensile strength is higher. A lower maximum amount of component (B) has the advantage that the laser light transparency of the composition is better.

One example of a composition according to the invention is one consisting of 100 pbw of component (A), 100 pbw of component (B) and 2.0 pbw of component (C). Herein component (B) is present in an amount of 49.5 wt. %, relative to the total weight of the composition. Another example of a composition according to the invention is one consisting of 100 pbw of component (A), 15 pbw of component (B) and 4 pbw of component (C). Herein component (B) is present in an amount of 12.6 wt. %, relative to the total weight of the composition. In case of a composition comprising, next to 100 pbw of component (A), 15 pbw of component (B) and 4 pbw of component (C), one or more further components, the weight percentage of component (B), can be lower than 12.6 wt. %, relative to the total weight of the composition, for example 10 wt. %. Suitably, the composition according to the present invention comprises component (B) in an amount in the range of 15-49.5 wt. %, relative to the total weight of the composition. The amount can be, for example, as low as, or about, 15 wt. %, 20 wt. %, or 25 wt. %, or as high as, or about, 48 wt. %, 44 wt. %, or 40 wt. %, relative to the total weight of the composition.

The metal in the metal salt of component (C) is an alkali metal. The alkali metal suitably is lithium, sodium or potassium, or a combination thereof. Preferably, the alkali metal is sodium or potassium, or a combination thereof, and more preferably consists of sodium.

The fatty acid in the fatty acid salt of component (C) suitably is a saturated fatty acid or an unsaturated fatty acid, or a combination thereof. The fatty acid may be a linear fatty acid or a branched fatty acid, or a combination thereof. The fatty acid may comprise hetero atoms, for example, a nitrogen atom, or may be free of hetero atoms.

Saturated fatty acids falling within the present invention and free of hetero atoms can be represented by the formula CₓH₂ₓO₂, wherein x is an integer in the range of 24-40.

Preferably, the fatty acid is a linear saturated fatty acid free of hetero atoms. Such preferred linear saturated fatty acid free of hetero atoms can be represented by the formula H₃C(CH₂)_{y}CO₂H, wherein y is an integer in the range of 22-38.

Examples of suitable linear saturated fatty acids are
lignocerinic acid (represented by formula C₂₄H₄₈O₂ or formula H₃C(CH₂)₂₂CO₂H);
pentacosylic acid, also known as pentacosanic acid (represented by formula C₂₅H₅₀O₂ or formula H₃C(CH₂)₂₃CO₂H);
cerotic acid, also known as hexacosanic acid (represented by formula C₂₆H₅₂O₂ or formula H₃C(CH₂)_{y24}CO₂H);
montanic acid, also known as n-octacosanic acid (represented by formula C₂₈H₅₆O₂ or formula H₃C(CH₂)₂₆CO₂H);
melissic acid, also known as triacontanoic acid (represented by formula C₃₀H₆₀O₂ or formula H₃C(CH₂)₂₈CO₂H);
lacceroic acid, also known as dotriacontanic acid (represented by formula C₃₂H₆₄O₂ or formula H₃C(CH₂)₃₀CO₂H);
tetratrianioc acid (represented by formula C₃₄H₆₈O₂ or formula H₃C(CH₂)₃₂CO₂H);
hexatrianioc acid (represented by formula C₃₆H₇₂O₂ or formula H₃C(CH₂)₃₄CO₂H); and
tetracontanioc acid (represented by formula C₄₀H₈₀O₂ or formula H₃C(CH₂)₃₈CO₂H).

In a preferred embodiment of the invention, component (C) is a salt of a fatty acid with 26-36 carbon atoms (also referred to as C26-C36 fatty acid), more preferably a salt of a fatty acid with 28-32 carbon atoms (also referred to as C28-C32 fatty acid).

In a further preferred embodiment of the invention, component (C) is a sodium salt or a potassium salt, or a combination thereof, of a C26-C36 fatty acid. More preferably, component (C) is a sodium salt or a potassium salt, or a combination thereof, of a C28-C32 fatty acid.

In a more preferred embodiment of the invention, component (C) is a sodium salt or a potassium salt of a linear saturated C26-C36 fatty acid. Examples thereof are sodium montanate, potassium montanate, sodium triacontanoate, potassium triacontanoate, sodium dotriacontanote, potassium dotriacontanote, sodium hexatrianoate and potassium hexatrianoate, and any mixtures thereof.

Component (C) is present in an amount in the range of 1.75-4.50 parts by weight (pbw), relative to 100 pbw of component (A). Suitably, the amount of component (C) is in the range of 1.9-4.0 pbw, relative to 100 pbw of component (A). Preferably, component (C) is present in an amount in the range of 2.0-3.75 pbw, more preferably 2.1-3.5 pbw, even more preferably 2.2-3.2 pbw, and most preferred 2.3-3.0 pbw, relative to 100 pbw of component (A). The effect of the limitation, or further limitation of the amount of component (C) in the said ranges is that the laser light transparency at 2.0 mm thickness is further increased while the reduction in mechanical properties is further limited.

Suitably, the laser-weldable fibre-reinforced polyester composition according to the invention comprises component (C) in an amount in the range of 1-3.3 wt. %, relative to the total weight of the composition. This on the provision that the requirement on the amount of component (C) in parts by weight, either 1.75-4.50 parts pbw, relative to 100 pbw of component (A), or where applicable a narrower range, is also met. The amount of component (C) can be, for example, as low as, or about, 1.1 wt. %, 1.2 wt. %, 1.5 wt. %, or 1.8 wt. %, or as high as, or about, 3.0 wt. %, 2.7 wt. %, or 2.5 wt. %, relative to the total weight of the composition.

Examples of suitable amounts of components (A), (B) and (C) in the laser-weldable fibre-reinforced polyester composition according to the invention are the following:
100 pbw of (A), 100 pbw of (B) and 2.0 pbw of (C); corresponding with 49.505 wt. % of (A), 49.9 wt. % of (B) and 0.990 wt. % of (C);
100 pbw of (A), 100 pbw of (B) and 3.75 pbw of (C), corresponding with 49.080 wt. % of (A), 49.0.80 wt. % of (B) and 1.840 wt. % of (C);
100 pbw of (A), 15 pbw of (B) and 2.0 pbw of (C), corresponding with 85.470 wt. % of (A), 12.821 wt. % of (B) and 1.709 wt. % of (C);
100 pbw of (A), 15 pbw of (B) and 3.75 pbw of (C), corresponding with 84.211 wt. % of (A), 12.632 wt. % of (B) and 3.158 wt. % of (C).
100 pbw of (A), 35 pbw of (B) and 3 pbw of (C), corresponding with 72.464 wt. % of (A), 25.362 wt. % of (B) and 2.174 wt. % of (C); and
100 pbw of (A), 70 pbw of (B) and 2.3 pbw of (C), corresponding with 58.038 wt. % of (A), 40.627 wt. % of (B) and 1.335 wt. % of (C).
   Herein the weight percentages (wt. %) are relative to the total amount of components (A), (B) and (C). In absence of further components in the composition, the weight percentages are also relative to the total weight of the composition.

The composition according to the present invention has a high transparency at least so at wavelengths typically applied for laser welding processes, more particular in the near infrared region (NIR) at wavelength in the range of 800-1200 nm. In a particular embodiment, the composition has a transparency of at least 25.0%, more particular at least 30.0%, and even more particular at least 40%, measured at 1.2 mm thickness and 980 nm by the procedure as described in the TMG3 User Manual Version 3.0, herein referred to as method according to TMG3, and mentioned herein further below (experimental part). In another particular embodiment, the composition has a transparency of at least 15.0%, more particular at least 17.5%, even more particular at least 20.0%, measured at 2.0 mm thickness and 980 nm by the method according to TMG3 as described herein further below. Herein the transparency measurement is done on injection moulded plaques with different thickness of respectively 1.2 mm (75×50 mm plaques), 2.0 mm or 3.0 mm (80×80 mm plaques). The injection moulding is done using standard PBT moulding conditions.

The transmission of the composition in the visible region (VR) at wavelengths in the range of about 400-700 nm, can vary over wide range and may be as high as in the NIR, but may also be much lower, depending on further additives present.

The laser-weldable fibre-reinforced polyester composition of the present invention may optionally comprise, next to components (A), (B) and (C), one or more further additives. These one or more further additives are herein jointly referred to as component (D). These one or more further additives may be any auxiliary additive used in fibre-reinforced polyester compositions. Examples thereof are particulate fillers, for example: glass beads, amorphous silica, asbestos, calcium silicate, calcium metasilicate, magnesium carbonate, kaolin, chalk, powdered quartz, mica, barium sulphate, and feldspar; other fibres, i.e., fibres different from glass fibres, for example: aramid fibres and potassium titanate fibres; processing aids; stabilizers, for example: heat stabilizers, light stabilizers and anti-oxidants; lubricants and mould-release agents; colorants, for example: dyes and pigments; and plasticizers, etc.

The additive or additives can be added at any desired stage by any suitable conventional manner during the preparation of the composition. Herein the additives may be added, for example, separately, or as a premix with one or more other components, or as a masterbatch. Suitably, the additive or additives are added as a masterbatch, comprising the additive or additives dispersed in a PBT resin.

The one or more further additives of component (D) are preferably used in such an amount that these do not corroborate, or only in limited extend, the laser light transparency and/or the mechanical properties of the composition. Suitably, the polyester composition of the invention comprises component (D), if at all, in an amount of at most 20 wt. %, preferably at most 15 wt. %, and most preferred in the range of 0-10 wt. %, relative to the total weight of the composition. The particulate fillers, if used at all, are suitably present in an amount of at most 15 wt. %, preferably at most 10 wt. %, and more preferably 0-5 wt. %, relative to the total weight of the composition. The other fibres, if used at all, are also suitably present in an amount of at most 15 wt. %, preferably at most 10 wt. %, and more preferably 0-5 wt. %, relative to the total weight of the composition.

Also more preferably, the combined amount of particulate fillers and other fibres, is in the range 0-15 wt. %, even more preferably 0-10 wt. % and most preferred 0-5 wt. %, relative to the total weight of the composition. Furthermore, fibres and fillers that have high laser light absorbency, for example carbon fibres, carbon black, graphite, graphene, or carbon nanotubes, are preferably present in an amount below 1 wt. %, more preferably in an amount in the range of 0-0.25 wt. %, and particularly preferably in an amount in the range of 0-0.05 wt. %, relative to the total weight of the composition.

Suitably, the composition according to the invention consists of
component (A) in an amount in the range of 40-85 wt. %;
component (B) in an amount in the range of 15-49.5 wt. %;
component (C) in an amount in the range of 1-3.3 wt. %;
component (D) in an amount in the range of 0-20 wt. %;
wherein the weight percentages (wt. %) relative to the total weight of the composition.

The composition according to the present invention may be neutral in colour, i.e., not comprising a colorant, or may be coloured, i.e., comprising a colorant, such as a pigment or dye.

Both organic and inorganic pigments and/or dyes are suitable as colorants. Inorganic pigments such as titanium dioxide, ultramarine blue, iron oxide and carbon black, furthermore organic pigments such as phthalocyanines, quinacridones, perylenes and dyes such as nigrosine and anthraquinones as colorants and other colorants can be added if these do not absorb in the range of the laser used. Otherwise, they may only be used in such small quantities that at least partial transmission of the laser light is still possible. Colorants such as soot and carbon black may be used but preferably only in very small amounts: preferably 0.1 wt. %, more preferably below 0.05 wt. % relative to the total weight of the composition.

Examples of inorganic pigments are antimony trioxide, antimony pentoxide, basic lead carbonate, basic lead sulphate or lead silicate, lithopone, titanium dioxide (anatase, Rutile), zinc oxide, zinc sulphide, metal oxides such as berlin blue, lead chromate, lead sulphochromates, chromium-antimony-titanate, chromium oxides, iron oxides, cobalt blue, cobalt-chromium blue, cobalt-nickel grey, manganese blue, manganese violet, molybdate orange, molybdate red, nickel-antimony-titanate and ultramarine, metal sulphides such as antimony trisulfide, cadmium sulphide, cadmium sulphoselenide, zirconium silicates, zirconium vanadium blue, zirconium praseodymium yellow.

Examples of organic pigments are antrachinone, azo, azomethine, benzanthron, quinacridone, quinophthalone, dioxazine, flavanthrone, indanthrone, isoindoline, isoindolinone, methine, perinone, perylene, phthalocyanine, pyranthrone, pyrrolo-pyrrole, thioindigo pigments and metal complexes of e.g. azo, azomethine, methine dyes or metal salts of azo compounds metal complexes of azo, azomethine or methine dyes, azomethine, quinacridone, dioxazine, isoindoline, isoindolinone, perylene, phthalocyanine, pyrrolo-pyrrole and thioindigo colorants and bismuth vanadate, anthraquinone series, for example alkylamino, amino, arylamino, cyclohexylamino, hydroxy, hydroxyamino or phenylmercapto-anthraquinones, triphenylmethane dyes, and fluorescent dyes, for example those from the benzothiazole, coumarin, oxarin or thiazine series, pyrazolone, perinone and anthraquinone methine, azo and coumarin type.

In a particular embodiment, the laser-weldable fibre-reinforced polyester composition according to the invention comprises a laser-light-transparent colorant. With a laser-light-transparent colorant is herein understood a colorant that absorbs light in the visible light region at a wavelength of less than 800 nm and transmits light in the infra-red region at 800 nm to 1200 nm.

Suitably, the composition comprises the laser-light-transparent colorant in an amount in the range of 0.1-3 wt. %, preferably 0.2-2.0 wt. %, more preferably 0.3-1.5 wt. %, relative to the total weight of the composition.

The laser-light-transparent colorant in this particular embodiment of the invention may be of any colour, or combination of colorants of different colours. Suitably the laser-light-transparent colorant is a black colorant or a non-black colorant, or any combination thereof. The non-black laser-light-transparent colorant may have any colour, for example: a red colorant, a yellow colorant, a green colorant, a blue colorant, or a violet colorant.

In a preferred embodiment of the invention, the laser-weldable fibre-reinforced polyester composition comprises a single black laser-light-transparent colorant, or a combination of a black laser-light-transparent colorant and at least one non-black laser-light-transparent colorant, or a combination of at least two non-black laser-light-transparent colorants providing a black colour. Such a combination of at least two non-black laser-light-transparent colorants providing a black colour is herein also referred to as ‘black-colouring combination’.

With a black colour is herein understood a colour with an L*-value, measured by the method according to ISO 7724-1-2-3, of at most 35. Accordingly, with a ‘black-colouring combination’ of colorants is herein understood a combination of colorants that provides a composition comprising said combination of colorants, a colour with an L*-value, measured by the method according to ISO 7724-1-2-3, of at most 35.

More preferably, the composition comprises a black-colouring combination of two or more different non-black laser-light-transparent colorants. The advantage of the composition comprising a black-colouring combination of two or more different non-black lapser-light-transparent colorants is that moulded parts with a black colour impression (comparable to colouring with soot) and very good surface quality can be produced, the composition retains a high laser light transparency in the range of non-coloured material and is suitable for many welding applications requiring dark coloured or black parts.

Such a black-colouring combination suitably comprises a mixture of colorants with different colours, i.e., absorbing at different wavelength in the visible region below 800 nm. There are many examples of combinations of mixed colorants that can be used to result in a black-colouring combination. Examples of dyes that can be used as non-black laser-light-transmitting colorants in such combinations are described, for example in EP1240243A1. Generally, dyes which exhibit blue, violet, and green colours can be main components to produce the black dyes. For instance, the combination of blue dye, red dye, and yellow dye; the combination of green dye, red dye and yellow dye; the combination of blue dye, green dye and red dye and yellow dye; and the combination of green dye, violet dye and yellow dye can be used. Examples thereof are combinations selected from the dyes from pyrazolone; perinone; anthraquinone, for example an anthraquinone green dye, an anthraquinone blue dye or an anthraquinone violet dye; methine, azo, and coumarin type; metal-containing pigments, such as inorganic pigments; metal complexes of azo, azomethine or methine dyes, azomethine, quinacridone, dioxazine, isoindoline, isoindolinone, perylene, phthalocyanine, pyrrolopyrrole and thioindigo type; quinophthalone dyes; metallic azo. More particular, neutral anthraquinone dyes imparting blue, violet, or green can be used as a major component of the resulting black-colouring combination by being mixed with red and then yellow dyes, may be used. Dyes belonging to monoazo complex dyes can be mixed with the anthraquinone dyes to produce a black dye for use as colorants in the composition. In other black-colouring combinations, a colorant amine salt of anthraquinone dye can be combined with a second dye selected from the group consisting of perinone dyes, monoazo complex dyes, anthrapyridone dyes and anthraquinone dyes.

Suitably, the composition comprises the black-colouring combination of at least two laser-light-transparent colorants in a total amount in the range of 0.1-3 wt. %, preferably 0.2-2.0 wt. %, more preferably 0.3-1.5 wt. %, relative to the total weight of the composition.

In a preferred embodiment, the composition comprising the black-colouring combination of the at least two non-black laser-light transmitting colorants has a transmission of at most 10% at least in spectral sub-ranges in the VIS spectral range (wavelength range of light from 400 nm to 700 nm).

In a further preferred embodiment of the invention, the laser-transparent fibre-reinforced polyester composition is a black composition having an L*-value of at most 35, preferably at most 33, more preferably at most 32. Herein the values for the colour parameter L* is measured by the method according to ISO 7724-1-2-3. A lower limit of L is 0 for a perfect black material, preferably L is at least 5.

In a particular preferred embodiment, the composition according to the invention is a black composition having a transparency of at least 25.0%, more particular at least 30.0%, and even more particular at least 40%, measured at 1.2 mm thickness and 980 nm by the method according to TMG3 as described herein further below. Even more preferably, the composition has further a transparency of at least 15.0%, more particular at least 17.5%, even more particular at least 20.0%, measured at 2.0 mm thickness and 980 nm by the method according to TMG3 as described herein further below.

The present invention also relates to a process for preparing the laser-weldable fibre-reinforced polyester composition of the invention. The composition, and the particular and preferred embodiments thereof, as described herein above, can be produced by processes known per se: by melt mixing the starting components (A), (B) and (C), and optionally also component (D), in the amounts as indicated above for the inventive composition or the various embodiments thereof.

The process according to the invention comprises melting of a polybutylene terephthalate resin and mixing (A) 100 parts by weight of the polybutylene terephthalate resin; (B) 15-100 parts by weight of glass fibres and (C) 1.75-4.5 parts by weight an alkali metal salt of a fatty acid with 24-40 carbon atoms. The melt-mixing can be done in conventional mixing apparatuses, such as single-screw extruders and double screw extruders, Brabender mixers, or Banbury mixers, and then extruding the same. The extrudate can be cooled, and optionally pelletized, granulated, grinded or reduced to particles or fragments otherwise. The mixing temperatures are suitably from 230 to 290° C.

The components can be added simultaneously, or separately. For example, components (A), (C) and (D) can be added to a first extruder inlet and mixed and heated, and component (B) can be added to a second extruder inlet and combined with the mixed components (A), (C) and (D).

The present invention also relates to a process making a moulded part from a laser weldable fibre-reinforced polyester composition. The process comprises moulding a laser weldable fibre-reinforced polyester composition into a preformed shape, the laser-weldable fibre-reinforced polyester composition being according to the present invention or any of the particular or preferred embodiments thereof as described herein above. The laser-weldable fibre-reinforced polyester compositions of the invention can be moulded by processes known per se: the moulded parts can be made, for example, by injection moulding. For such a process, conventional equipment and conventional process conditions can be used.

The present invention also relates to a laser-light-transparent moulded part made of a laser-weldable fibre-reinforced polyester composition. Herein the laser-weldable fibre-reinforced polyester composition is a composition according to the present invention, or any of the various embodiments thereof, as described herein above.

The moulded parts are suitable for producing laser welded products. The laser transparency of these moulded parts is preferably at least 25.0%, more particular at least 30.0%, and even more particular at least 40%, measured at 1.2 mm thickness and 980 nm by the method according to TMG3 as described herein further below (experimental part). The moulded parts preferably also have a transparency of at least 15.0%, more particular at least 17.5%, even more particular at least 20.0%, measured at 2.0 mm thickness and 980 nm by the method according to TMG3 as described herein further below.

The advantage of these moulded parts is not only that these exhibit an overall better balance in laser light transparency and mechanical properties, i.e. tensile strength, tensile elongation at break and/or impact resistance, but also require shorter laser welding cycle times to reach a pre-set level of weld strength, or alternatively, reach a higher weld strength with a pre-set laser welding cycle time, compared to other moulded parts made of other fibre-reinforced PBT composition with similar laser light transparency but based on other transparency enhancing additives.

These advantages are further enhanced for the compositions with 1.9-4.0 pbw of component (B), even better with 2.0-3.75 pbw of component (B), more particular with 2.1-3.5 pbw of component (B), and even more particular with 2.2-3.0 pbw of component (B), relative to 100 pbw of component (A).

The present invention also relates to a process for producing a composite article by laser welding. Such a process comprises irradiating a laser beam on a contact surface of a laser-light-transparent moulded part and a laser-light-absorbent polymeric substrate, thereby forming a welded bond between the laser-light-transparent moulded part and the laser-light-absorbent polymeric substrate. The process of laser welding, also known as laser transmission welding, and equipment used therein are known in the art. The fundamental principles of laser welding are described in the technical literature, for example in Plastverarbeiter 46 (1995) 9, 42-46, Kunststoffe 87, (1997) 3, 348-350; Kunststoffe 87 (1997) 11, 1632-1640; Kunststoffe 88, (1998), 2, 210-212; and Plastverarbeiter 50 (1999) 4, 18-19. An example of such a process, and apparatus used therein is described, for example, in European patent EP1048439B1.

In the process according to the invention, the laser-light-transparent moulded part is made of a laser weldable fibre-reinforced polyester composition according to the present invention, or any of the various embodiments thereof, as described herein above.

In the process according to the invention, a moulded part made of a laser transparent fibre-reinforced polyester composition according to the present invention, or any specific embodiment thereof as described above, is combined with a laser-light-absorbent polymeric substrate, and subjected to a laser welding process to form a bonded laser welded article. The laser-light-absorbent polymeric substrate can be any moulded part made of any laser-light-absorbent polymeric material. By way of example, these can be thermoplastic materials, thermoset materials, or composite materials. Preferably, the laser-light-absorbing polymeric substrate is made of a thermoplastic composition comprising a thermoplastic polymer and having adequate laser light absorption in the wavelength range used. The thermoplastic polymer in the laser-light-absorbing polymeric substrate preferably is a thermoplastic polymer that is miscible with the PBT in the laser-weldable fibre reinforced polyester composition. More preferably, the thermoplastic composition comprises a thermoplastic polyester. The thermoplastic polyester can be, for example, PBT, or PET, or PCT, or any mixture or any copolymer thereof. Most preferred, the thermoplastic composition in the laser-light-absorbent polymeric substrate comprises PBT.

The thermoplastic composition can suitably be made laser-light-absorbent by virtue of addition of inorganic pigments, organic pigments, or fillers, or of other additives, or any combination thereof. Suitable additives are known in the art. Examples thereof are carbon fibres, carbon black, graphite, graphene, and carbon nanotubes. Highly effective in absorption of laser light are carbon black and graphite. Either carbon black or graphite, or a combination thereof is preferably used in the laser-light-absorbent substrate.

For the laser welding process according to the invention, the advantages mentioned above for the moulded parts on the overall better balance in laser light transparency and mechanical properties, and the shorter laser welding cycle times or the higher weld strength apply here as well.

The present invention also relates to a composite article comprising a laser-light-transparent moulded part bonded by laser welding on a laser-light-absorbent polymeric substrate. Herein the laser-light-transparent moulded part, laser welded onto a laser-light-absorbent polymeric substrate, is made of a laser-weldable fibre-reinforced PBT composition according to the present invention, or any of the various embodiments thereof, as described herein above. The advantage of such article is not only that the laser-weldable fibre-reinforced PBT composition has an overall better balance in laser-light-transparency and mechanical properties, as reported above, but also that the laser welded article with the two moulded parts welded together has a higher weld strength with the same cycle time applied or can be obtained with the same weld strength with a shorter laser welding cycle time.

In a preferred embodiment of the invention, the laser-light-absorbent polymeric substrate in the composite article and used in the laser welding process for making the composite article is made of a thermoplastic composition comprising carbon black and/or graphite and a polybutylene terephthalate resin (PBT).

The invention is further illustrated with the following examples and comparative experiments.

### RESULTS

### Raw Materials

A1: Polybutylene terephthalate with a melting temperature of 224±2° C. (measured at a heating ramp ° C./minute by the method according to ISO11357), a relative solution viscosity (RSV) of 2.36±0.04 dl/g (measured in m-cresol at a concentration of 1 g in 100 g m-cresol at a temperature of 25° C. by the method according to ISO 307) and a melt volume rate (MVR) of 11.5+1.0 cm3/10 min (measured at 250° C., 2.16 kg by the method according to ISO 1133).
B1: Glass fibres: E-glass, standard grade chopped fibres for thermoplastic polyester injection moulding compounds
C1: Sodium salt of montanic acid
C2: Sodium stearate (sodium salt of stearic acid)^{#}
C3: Sodium myristate (for comparison purposes)^{#}
C4: Magnesium salt of montanic acid^{#}
C5: Aluminium salt of montanic acid^{#}
D1: Black-colouring combination of non-black laser-light-transparent colorants
Composition T: BASF LUX B4300 G6^{#}
Composition laser-light-absorbent polymeric substrate: PBT TV4 261 BK00001 (Standard carbon black filled PBT 30 wt. % glass fiber grade)
^{#}C2, C3, C4 and C5 and Composition T are not according to the present invention; and are used herein for comparison purposes only.

### Processing

### Compounding

The moulding compositions were produced in a ZSK25 twin-screw extruder with a flat temperature profile from 250 to 260° C. and with pelletization. Components (A), (B) and (D) were premixed and dosed at the throat, component (B) was dosed at a side feeder.

### Moulding

Prior to moulding the materials were dried for 16 hrs at 120° C. inside a vacuum oven with a N2 purge. For the preparation of the test samples, injection moulding was done on a Fanuc-2 injection machine, type α-S50iA, provided with an appropriate mould cavity, and applying a barrel temperature of 260° C. and a mould cavity temperature of 90° C.
For the laser light transparency test, test samples of 75×50 mm and a thickness of 1.2 mm, and test samples of 80×80 mm and a thickness of respectively 2.0 and 3.0 mm were prepared.
For the tensile test, test samples according to ISO 527-1A were prepared.
For the unnotched impact test, test samples according to ISO 179/1eU were prepared.
For the laser welding test, test samples with dimensions of a cover for an automotive radar mould housing and a thickness of 1 mm were prepared.

### Laser Welding

Laser welding was done using the process and apparatus as described in European patent EP1048439B1, using low, medium and high settings for laser power (200 W, 250 W and 300 W; W=watt), welding speed (1000 mm/s, 2000 mm/s and 4000 mm/s) and clamping pressure (3.1 N/(mm²), 6.2 N/(mm²) and 9.2 N/(mm²)) as reported in Table 5.

### Test Methods

### Laser Light Transparency Measurement

The laser-light-transparency was measured on injection moulded test samples with a thickness of 1.2 mm (75×50 mm plaques), 2.0 mm (80×80 mm plaques), and 3.0 mm (80×80 mm plaques), using a TMG3 measuring unit equipped with laser light source irradiating light with a wavelength 980 nm by applying the procedure as described in the TMG3 User Manual Version 3.0 (herein referred to as method according to TMG3). The TMG3 measuring unit was made available by LPKF WeldingQuipment GmbH, Alfred-Nobel-Straße 55-57, 90765 Fürth Germany.

### Mechanical Properties

The tensile strength and tensile elongation-at-break were measured in a tensile test carried out at 23° C. with a drawing rate of 5 mm/min by the method according to ISO 527-1A (2019).
Charpy unnotched impact resistance was measured at 23° C. by the method according to ISO 179/1eU.

### Viscosity

The relative solution viscosity of the polymers was measured in m-cresol at a concentration of 1 g in 100 g m-cresol at a temperature of 25° C. by the method according to ISO 307.

### Colour Parameters

Colour parameter L* was measured on the plaques used for the laser light transmission tests at 23° C. by the method according to ISO 7724-1-2-3, measured with a Minolta CM-3700d spectrophotometer using a Xenon light source.

### Compositions and Test Results

The compositions according to the present invention (Examples) and of comparative nature (Comparative Experiments) and test results obtained with these Examples and Comparative Experiments are reported in Tables 1-5.

TABLE 1
Compositions and test results for Examples I-V and Comparative Experiments A-B and U.

| | Experiment/Component | | | | | | | |
|---|---|---|---|---|---|---|---|---|
| | CE-A | CE-B | EX-I | EX-II | EX-III | EX-IV | EX-V | CE-U |
| A1 (wt. %) | 68 | 67.30 | 66.60 | 66.25 | 65.90 | 65.55 | 65.20 | 64.85 |
| B1 (wt. %) | 30 | 30 | 30 | 30 | 30 | 30 | 30 | 30 |
| C1 (wt. %) | 0 | 0.70 | 1.40 | 1.75 | 2.10 | 2.45 | 2.80 | 3.15 |
| D (wt. %) | 2 | 2 | 2 | 2 | 2 | 2 | 2 | 2 |
| C1 (phr; vs. A1) | 0 | 1.04 | 2.10 | 2.64 | 3.19 | 3.74 | 4.29 | 4.86 |
| C1 (wt. % vs A1 + C1) | 0 | 1.0 | 2.00 | 2.50 | 3.00 | 3.50 | 4.00 | 4.50 |
| Mechanical Properties | | | | | | | | |
| TS (MPa) | 134.2 | 143.8 | 145.5 | 139.5 | 135.5 | 132 | 129.2 | 124 |
| EaB (%) | 3.76 | 3.84 | 3.8 | 2.66 | 2.46 | 2.39 | 2.32 | 2.23 |
| Charpy (unnotched) | 73.7 | 73.7 | 70.2 | 45.7 | 44.5 | 39.6 | 38.7 | 31.3 |
| (kJ/m²) | | | | | | | | |
| Laser Light Transmission | | | | | | | | |
| LLT-1.2 mm (%) | 14.5 | 15.7 | 27.8 | 53.4 | 52.3 | 50.1 | 49.9 | 49.1 |
| LLT-2.0 mm (%) | 5.6 | 8.0 | 17.2 | 27.4 | 23.0 | 18.9 | 16.3 | 12.6 |
| LLT-3.0 mm (%) | 2.1 | 3.2 | 5.7 | 11.6 | 9.2 | 6.5 | 5.0 | 4.7 |

The test data show surprisingly good results in both the laser light transparency and in the mechanical properties for the compositions of the Examples according to the invention. The laser light transparency shows a relatively small increase for the composition of CE-B comprising about 1 pbw of sodium montanate (component C1), compared to the composition CE-A comprising only PBT, glass fibers and additives D, but lacking said component C1. However, the laser light transparency shows a steep increase at an amount of component C1 beyond 1 pbw, rising to a laser light transparency 3.5-4 times as high of that of CE-A for composition of EX-II comprising 2.61 pbw of component C1. For the compositions comprising C1 in an amount above said 2.61 pbw, the laser light transparency levels of and slowly goes down, but even at a content of 4.26 pbw of component C1 (EX-V), the laser light transparency is still higher than that of CE-B, while the mechanical properties are retained at a good level. At a content of 4.86 pbw of component C1 (CE-U), the laser light transparency is slightly lower, but still higher than that of CE-B, however, the impact resistance has fallen below 50% of that of comparative experiments CE-A and CE-B.

TABLE 2
Compositions and test results for Comparative Experiments C-H.

| | Experiment/Component | | | | | |
|---|---|---|---|---|---|---|
| | CE-C | CE-D | CE-E | CE-F | CE-G | CE-H |
| A1 (wt. %) | 68 | 67.30 | 66.95 | 66.60 | 66.25 | 65.90 |
| B1 (wt. %) | 30 | 30 | 30 | 30 | 30 | 30 |
| C2 (wt. %) | 0 | 0.70 | 1.05 | 1.40 | 1.75 | 2.10 |
| D (wt. %) | 2 | 2 | 2 | 2 | 2 | 2 |
| C2 in phr; vs A1 | 0 | 1.04 | 1.57 | 2.10 | 2.64 | 3.19 |
| C2 in wt. % vs A1 + C2 | 0 | 1 | 1.5 | 2 | 2.5 | 3 |
| Mechanical Properties | | | | | | |
| (TS (MPa) | 133.9 | 135.4 | 121 | 105.4 | 91.84 | 81.81 |
| EaB (%) | 3.33 | 2.14 | 1.85 | 1.57 | 1.35 | 1.24 |
| Charpy (unnotched) | 66.4 | 43.2 | 27.6 | 28.4 | 25.6 | 24.8 |
| (kJ/m²) | | | | | | |

TABLE 3
Compositions and test results for Comparative Experiments C and I-M.

| | Experiment/Component | | | | | |
|---|---|---|---|---|---|---|
| | CE-C | CE-I | CE-J | CE-K | CE-L | CE-M |
| A1 (wt. %) | 68 | 67.65 | 67.30 | 66.95 | 66.60 | 66.25 |
| B1 (wt. %) | 30 | 30 | 30 | 30 | 30 | 30 |
| C3 (wt. %) | | 0.35 | 0.70 | 1.05 | 1.40 | 1.75 |
| D (wt. %) | 2 | 2 | 2 | 2 | 2 | 2 |
| C3 in phr vs A1 | 0 | 0.52 | 1.04 | 1.57 | 2.10 | 2.64 |
| C3 in wt. % vs A1 + C2 | 0 | 0.5 | 1 | 1.5 | 2 | 2.5 |
| Mechanical Properties | | | | | | |
| TS (MPa) | 133.9 | 147.3 | 145.9 | 134.6 | 108.9 | 93.15 |
| EaB (%) | 3.33 | 2.96 | 2.59 | 2.06 | 1.73 | 1.42 |
| Charpy (unnotched) | 66.4 | 59.4 | 52.3 | 40 | 30.9 | 32 |
| (kJ/m²) | | | | | | |

TABLE 4
Compositions and test results for Comparative Experiments A and N-S.

| | Experiment/Component | | | | | | |
|---|---|---|---|---|---|---|---|
| | CE-A | CE-N | CE-O | CE-P | CE-Q | CE-R | CE-S |
| A1 (wt. %) | 68 | 66.95 | 66.60 | 65.90 | 66.95 | 66.60 | 65.90 |
| B1 (wt. %) | 30 | 30 | 30 | 30 | 30 | 30 | 30 |
| C4 (wt. %) | 0 | 1.05 | 1.40 | 2.10 | | | |
| C5 (wt. %) | 0 | | | | 1.05 | 1.40 | 2.10 |
| D (wt. %) | 2 | 2 | 2 | 2 | 2 | 2 | 2 |
| C4/C5 (phr) | 0 | 1.57 | 2.10 | 3.19 | 1.57 | 2.10 | 3.19 |
| C4/C5 (phr) | 0 | 1.57 | 2.10 | 3.19 | 1.57 | 2.10 | 3.19 |
| Laser Light Transmission ^{#} | | | | | | | |
| LLT-1.2 mm (%) | 14.5 | v.l. | v.l. | v.l. | v.l. | v.l. | v.l. |
| LLT-2.0 mm (%) | 5.6 | v.l. | v.l. | v.l. | v.l. | v.l. | v.l. |
| LLT-3.0 mm (%) | 2.1 | v.l. | v.l. | v.l. | v.l. | v.l. | v.l. |

^{#} v.l. = very low

The mechanical properties for the compositions of the Examples according to the invention, i.e., the tensile strength, the elongation at break and the unnotched Charpy impact resistance are better than those of Comparative Experiments with corresponding amounts of sodium stearate (component C2) or sodium myristate (component C3). For all three components C1, C2 and C3 there is a down going trend for the tensile strength, the elongation at break and the unnotched Charpy impact resistance with increasing content of respectively C1, C2 and C3. However, components C2 and C3 show similar trends, which differ from those for component C1, in that the down-going trends start at a lower amount and/or that the decrease in measured value is larger. For component C1 the down-going trends start at a higher content and/or that the decrease in measured value is smaller.

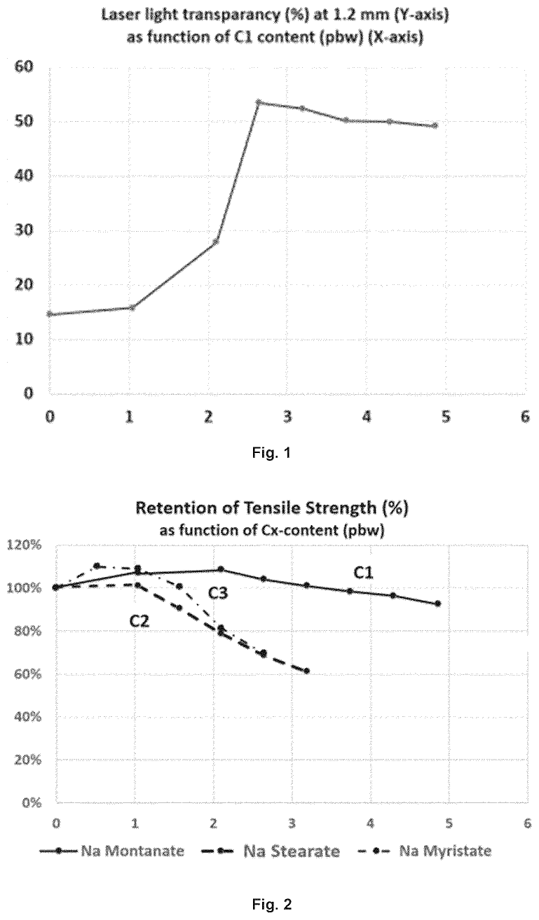

Furthermore, a simple lab test showed that the laser light transparency of Comparative Experiments corresponding with compositions based on the magnesium salt of montanic acid (component C4) and the aluminium salt of montanic acid (component C5) was very low, comparable to or even lower than for the composition of Comparative Experiment A (CE-A), and certainly much lower than laser light transparency of the compositions of Examples I-V.
Part of the test results are also shown in the FIGS. 1-4.

FIG. 1 shows a graphical representation for the laser light transparency measured at 980 nm and 1.2 mm thickness of the compositions comprising different amounts of N-montanate (examples EX-I-EX-V and comparative experiments CE-A and CE-B). As can be seen, beyond 1 phr there is a stee increase in laser light transparency up to about 2.5 phr, beyond which the laser light transparency levels of.

FIG. 2 shows a graphical representation for the retention of the tensile strength as function of different amounts of Na-montanate (C1), Na-stearate (C2) and Na-myristate (C3).

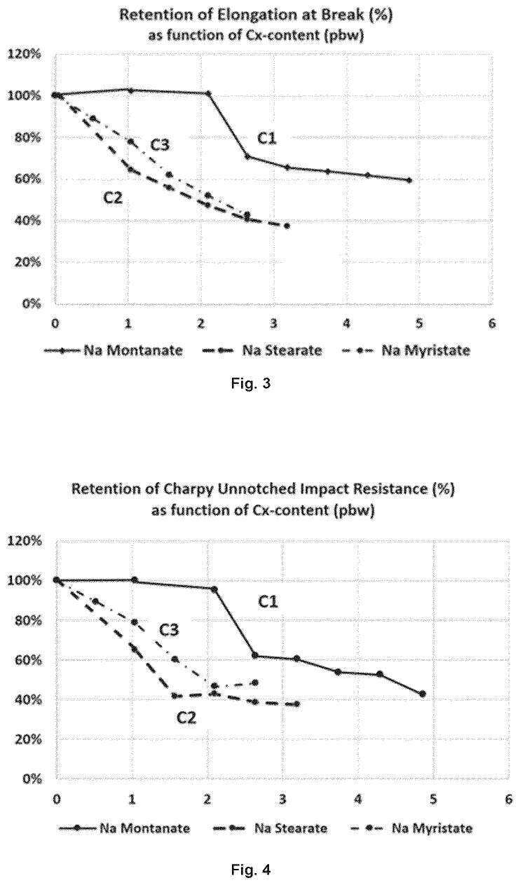

FIG. 3 shows a graphical representation for the retention of the elongation-at-break as function of different amounts of Na-montanate (C1), Na-stearate (C2) and Na-myristate (C3).

FIG. 4 shows a graphical representation for the retention of the unnotched impact resistance as function of different amounts of Na-montanate (C1), Na-stearate (C2) and Na-myristate (C3).

As can be seen from all three FIGS. 2, 3 and 4, Na-stearate (C2) and Na-myristate (C3) show a steep drop in elongation-at-break and unnotched impact resistance at a content of 0.5 or 1 pbw, relative to 100 pbw of PBT and for the tensile strength at 1.5 pbw, relative to 100 pbw of PBT. In all three graphs Na-myristate (C3) shows a slight better performance than Na-stearate (C2) for the compositions with a Cx content in the range of 0.5-2.5 pbw, relative to 100 pbw of PBT. Meanwhile the properties are much better retained for the compositions comprising Na-montanate (C1). Even at a content of 4.5 pbw of Na-montanate (C1), relative to 100 pbw of PBT, all three properties of tensile strength, elongation-at-break and unnotched impact resistance are still at a higher retention level than those for the composition with Na-stearate (C2) at a content of 1.5 pbw, relative to 100 pbw of PBT.

TABLE 5
Laser Light Transmission and welding results for Examples
III-IV and Comparative Experiments CE-A and CE-T.

| Product/Composition | CE-A | CE-T | EX-V | EX-III |
|---|---|---|---|---|
| A1 (wt. %) | 68 | | 65.20 | 65.90 |
| B1 (wt. %) | 30 | | 30 | 30 |
| C1 (wt. %) | 0 | | 2.80 | 2.10 |
| CX (wt. %) | 0 | | 0 | 0 |
| D (wt. %) | 2 | | 2 | 2 |
| C1/CX (phr) | 0 | | 4.29 | 3.19 |
| LLT (1 mm) (%) | 16-17 | 42-56 | 48-52 | 52-58 |
| Welding time (s) vs laser power | | | | |
| Low energy | 3.9 | 3.4 | 2.7 | 2.4 |
| Medium energy | 3.0 | 2.4 | 1.8 | 1.7 |
| High energy | 2.5 | 1.8 | 1.4 | 1.3 |
| Welding time (s) vs welding speed | | | | |
| Low welding speed | | 2.0 | 1.6 | 1.4 |
| Medium welding speed | | 1.9 | 1.4 | 1.3 |
| High welding speed | | 2.1 | 1.7 | 1.5 |
| Welding time (s) vs clamping pressure | | | | |
| Low clamping pressure | | 2.2 | 1.6 | 1.5 |
| Medium clamping pressure | | 1.8 | 1.4 | 1.3 |
| High clamping pressure | | 1.6 | 1.4 | 1.2 |

Table 5 shows the laser light transmission and welding test results for two Examples (EX-III and EX-IV) and for two Comparative Experiments (CE-A and CE-T). CE-A is a fibre-reinforced polyester composition without additive to enhance the laser-light transparency, and CE-T is a commercially available product with high transparency but with unknown composition.

The data in the table show surprisingly good results in terms of welding behaviour for Examples II and III, both representing compositions according to the present invention. Herein the performance is much better than for the two Comparative Experiments, which is not surprising in view CE-A lacking an additive to enhance the laser-light transparency, but is highly surprising in respect of CE-T, which itself has a relatively high laser-light transparency.

1. A laser-weldable fibre reinforced polyester composition comprising:
(A) a polybutylene terephthalate resin (PBT);
(B) glass fibres; and
(C) an alkali metal salt of a fatty acid with 24-40 carbon atoms;
wherein component (B) is present in an amount in the range of 15-100 parts by weight, relative to 100 parts by weight of component (A), and component (C) is present in an amount in the range of 1.75-4.50 parts by weight, relative to 100 parts by weight of component (A).

2. A laser-weldable fibre reinforced polyester composition according to claim 1, wherein the polybutylene terephthalate resin (A) is a PBT homopolymer, or a PBT copolymer containing at least about 85 mol of copolymerized units of butylene (butylene units) and terephthalate (terephthalate units) and at most about 15 mol of copolymerized units of further comonomers (comonomer units), wherein the mol percentages (mol) of butylene units, terephthalate units and comonomer units are all relative to the total molar amount of moles of butylene units, moles of terephthalate units and moles of comonomers units in the copolymer.

3. A composition according to claim 1, wherein the polybutylene terephthalate resin (A) has a relative solution viscosity (RSV) Herein, the relative solution viscosity (RSV) is measured in m-cresol at a concentration of 1 g in 100 g m-cresol at a temperature of 25° C. by the method according to ISO 307, in the range of 1.5-2.8 dl/g.

4. A composition according to claim 1, wherein component (B) is present in an amount in the range of 25-80 parts by weight (pbw), preferably 30-70 pbw, more preferably 35-60 pbw, relative to 100 pbw of component (A).

5. A composition according to claim 1, wherein the alkali metal in component (C) is sodium or potassium, or a combination thereof.

6. A composition according to claim 1, wherein the fatty acid in component (C) is a fatty acid with 26-36 carbon atoms, preferably a fatty acid with 28-32 carbon atoms.

7. A composition according to claim 1, wherein component (C) is present in an amount in the range of 2.0-3.75 parts by weight (pbw), more preferably 2.1-3.5 pbw, even more preferably 2.2-3.2 pbw, and most preferred 2.3-3.0 pbw, relative to 100 pbw of component (A).

8. A composition according to claim 1, consisting of
40-85 wt. % of component (A);
15-49.5 wt. % of component (B);
1-3.3 wt. % of component (C); and
0-20 wt. % of one or more additives (component (D));
wherein the weight percentages (wt. %) relative to the total weight of the composition.

9. A composition according to claim 1, wherein the composition comprises a laser light transparent colorant, preferably a black laser light transparent colorant, or a black-colouring combination of two or more different non-black laser light transparent colorants.

10. A composition according to claim 1, wherein the composition has a laser-light-transparency of at least 25.0%, preferably at least 30.0%, and more preferably at least 40%, at 1.2 mm thickness, or at least 15.0%, preferably at least 17.5%, and more preferably at least 20%, at 2.0 mm thickness, measured and 980 nm by the method according to TMG3 as described herein above.

11. A process for preparing a laser weldable fibre-reinforced polyester composition by melt-mixing, the process comprising melting of a polybutylene terephthalate resin and mixing (A) 100 parts by weight of the polybutylene terephthalate resin; (B) 15-100 parts by weight of glass fibres and (C) 1.75-4.5 parts by weight an alkali metal salt of a fatty acid with 24-40 carbon atoms.

12. A process according to claim 11, where the laser weldable fibre-reinforced polyester composition is a composition.

13. A process for making a moulded part from a laser weldable fibre-reinforced polyester composition, comprising moulding a laser weldable fibre-reinforced polyester composition into a preformed shape, the laser-weldable fibre reinforced polyester composition comprising
(A) a polybutylene terephthalate resin;
(B) glass fibres; and
(C) an alkali metal salt of a fatty acid with 24-40 carbon atoms;
wherein component (B) is present in an amount in the range of 15-100 parts by weight and component (C) is present in an amount in the range of 1.75-4.5 parts by weight, relative to 100 parts by weight of component (A).

14. A process according to claim 13, wherein the laser weldable fibre-reinforced polyester composition is a composition.

15. A laser-light-transparent moulded part made of a laser weldable fibre-reinforced polyester composition comprising
(A) a polybutylene terephthalate resin;
(B) glass fibres; and
(C) an alkali metal salt of a fatty acid with 24-40 carbon atoms;
wherein component (B) is present in an amount in the range of 15-100 parts by weight and component (C) is present in an amount in the range of 1.75-4.5 parts by weight, relative to 100 parts by weight of component (A).

16. A laser-light-transparent moulded part according to claim 15, wherein the laser weldable fibre-reinforced polyester composition is a composition.

17. A process for producing a composite article by laser welding, which comprises irradiating a laser beam on a contact surface of a laser-light-transparent moulded part and a laser-light-absorbent polymeric substrate, thereby forming a welded bond between the laser-light-transparent moulded part and the laser-light-absorbent polymeric substrate, wherein the laser-light-transparent moulded part is made of a laser weldable fibre-reinforced polyester composition as mentioned in claim 1.

18. A composite article comprising a laser-light-transparent moulded part bonded by laser welding on a laser-light-absorbent polymeric substrate, wherein the laser-light-transparent moulded part is made of a laser weldable fibre-reinforced polyester composition as mentioned in claim 1.
